(19) United States
(12) Patent Application Publication
(10) Pub. No.: US 2008/0312961 A1
(43) Pub. Date: Dec. 18, 2008

(54) Managing Deployment of Clinical Guidelines

(75) Inventor: Yasser Alsafadi, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/097,586

(22) PCT Filed: Dec. 11, 2006
(86) PCT No.: PCT/IB2006/054746

§ 371 Date: Jun. 16, 2008

Related U.S. Application Data
(60) Provisional application No. 60/751,427, filed on Dec. 16, 2005.

(51) Int. Cl. G06Q 50/00; G06F 9/30

(52) U.S. Cl. 705/2; 712/220; 712/E09.016

(57) ABSTRACT

Variable and ambiguous factors in clinical guideline execution are further defined by prior expert medical scrutiny and testing. The definitions promote uniformity and ease of use, afford efficient interpretation by a medical device which can variably invoke the guideline (160) suited to the sensed current situation, and facilitate enterprise-wide administration of the rules under which a guideline for current operation is selected, preferably based on an ontology language (140). Guidelines are automatically deployed, and the deployment is managed. A patient care guideline formulated, medically approved and released includes logical structure (516) that has been specifically tailored to at least one value of at least one, but fewer than all, of a plurality of variables. Each of a set of clinical guidelines, including that guideline, is within a range of a function of the variables. A processor evaluates the function to select, from among the set, that guideline for current execution (S620). In another aspect, a medical device identifies a medically-approved clinical guideline for current execution and, responsive to the identification, the device automatically performs the guideline.

The present invention relates to managing deployment of clinical guidelines and, more particularly, to the facilitation of managing an enterprise-wide deployment of clinical guidelines that are automatically adapted to variables reflective of the situation in which the guideline is applied.

Many professional societies and health care organizations prepare guidelines for the care of patients. Some examples are the Institute for Clinical Systems Improvement (ISCI), the American College of Physicians (ACP-ASIM), and the American College of Radiology (ACR). A clinical guideline or “guideline” is an algorithm for clinical care of a patient which has been clinically tested, and released after expert review by a medical body such as those mentioned above.

A report entitled “Crossing the Quality Chasm: A New Health System for the 21st Century (2001),” by the Institute of Medicine (IOM), promotes the use of clinical decision support systems (CDSS) to handle the avalanche of information, and to cope with the complexity and chronic nature of diseases. A growing body of evidence demonstrates that the use of clinical practice guidelines with other supportive tools, such as reminder systems, can improve effectiveness of patient care. Utilization of clinical guidelines tends to increase the uniformity of medical care, independently of the know-how or level of experience of the particular treating physician. In addition, following the clinical guideline avoids the potential for unnecessary referrals to a preferred medical facility or provider. Moreover, it facilitates evidence-based medicine, by virtue of the guideline formation and issuance process. It is anticipated that reimbursement under Medicare and Medicaid may come to depend upon adherence to clinical guidelines.

Currently, the metes and bounds by which guidelines are deployed and used are general. Many guidelines are vague as to when and where they are applicable. For example, some guidelines are to be used during the week, when full medical staff is available. A variation of the guideline is to be applied on weekends, or at night. Some guidelines are applicable in the urban part of a health care enterprise, whereas a variation of the guideline is applicable in the rural part. Consequently, inferring applicability of guidelines to a particular circumstance or condition is ad-hoc in nature, which does not lend itself to efficient machine interpretation. One guideline, for example, states, “ . . . during the day, primarily angioplasty is the preferred strategy, whereas on nights and weekends thrombolysis is considered (and might be preferred),” quoting from “Emergency Department Critical Pathways for Acute Coronary Syndromes,” by Cannon C P and Richards C F, Lippincott, Williams & Wilkins (2001). An ICSI guideline, “Treatment of Acute Myocardial Infarction,” (2002), states, “ . . . institutions wishing to apply primary PCI for STEMI should achieve a median door to balloon time of 90 minutes or less . . . Institutions that can't meet the recommended treatment times should consider preferential use of intravenous thrombolytic therapy. These institutions should have a predefined plan for treating patients who present with contraindication to thrombolytics.”

Since the boundaries of health care delivery and the health care enterprise are constantly evolving due to changing environment, there exists a need for definitions that support temporal or situational changes.

In one aspect of the present invention, care processes are automatically deployed, and the deployment is managed. First, a clinical guideline for patient care is formulated, medically approved and released. The guideline includes logical structure that has been specifically tailored to at least one value of at least one, but fewer than all, of a plurality of variables. Each of a set of clinical guidelines, including that guideline, is within a range of a function of the variables. In operation, a processor evaluates the function to select, from among the set of guidelines, the guideline for current execution.

In another aspect, a medical device identifies a medically-approved clinical guideline for current execution. Responsive to the identification, the device automatically performs the identified guideline. It is preferably determined whether the identified guideline conflicts with another medically-approved clinical guideline, and performance is precluded or interrupted if it is determined that conflict exists.

Details of the novel paradigm for clinical guideline deployment are set forth below with the aid of the following drawings, wherein similar features are annotated with the same reference numerals throughout:

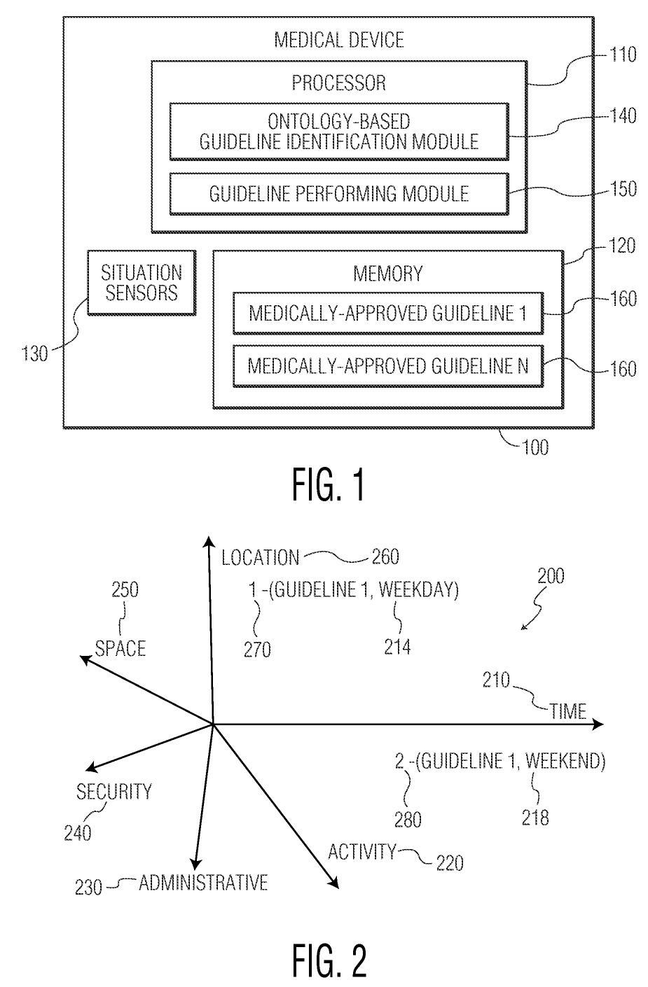

FIG. 1 is block diagram of a medical device according to the present invention;

FIG. 2 is a conceptual diagram of a domain of a function for selecting a guideline for current operation, in accordance with the present invention;

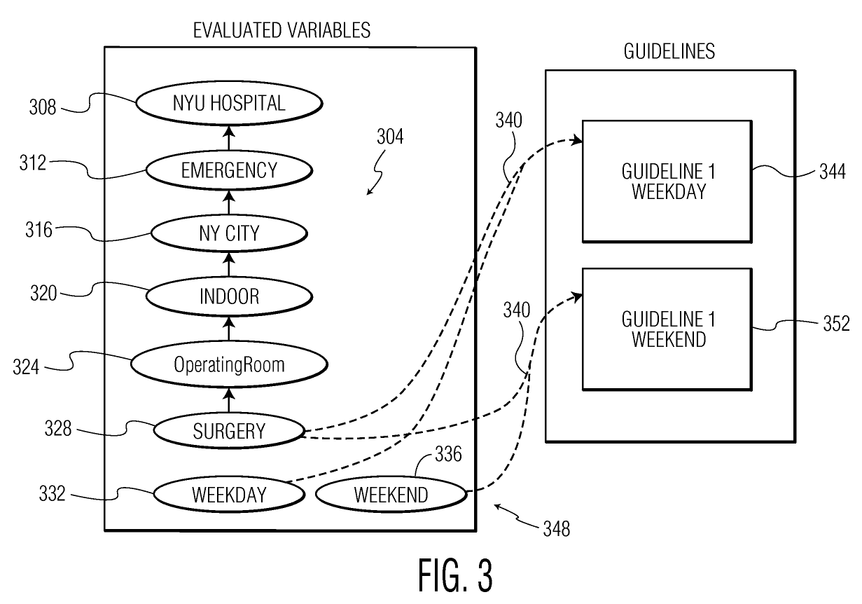

FIG. 3 is a conceptual diagram of a first embodiment demonstrating an instance of function evaluation in selecting a guideline for current operation, in accordance with the present invention;

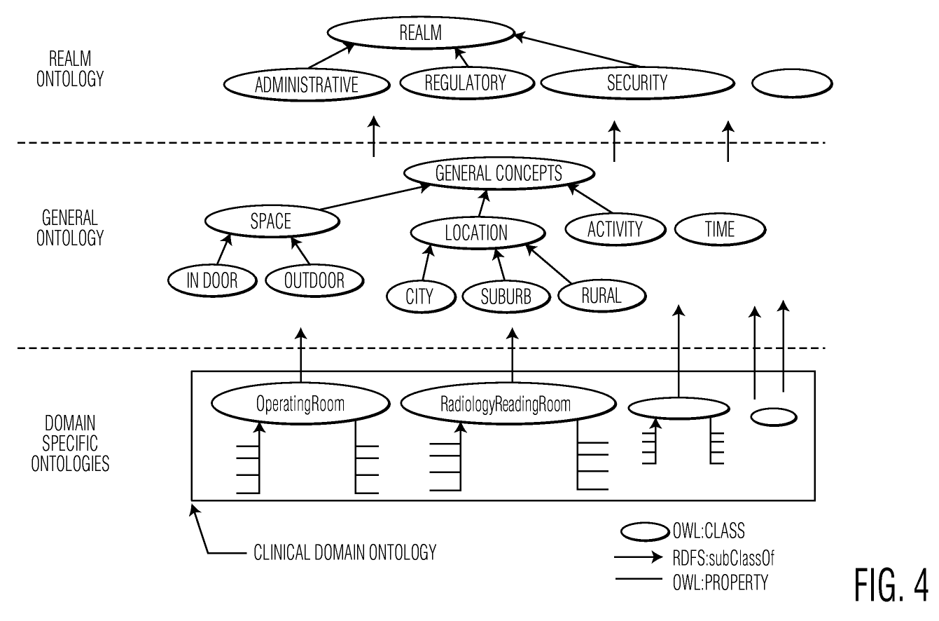

FIG. 4 is conceptual diagram demonstrating an example of how functional mapping to identify a guideline for current execution is organized according to ontology;

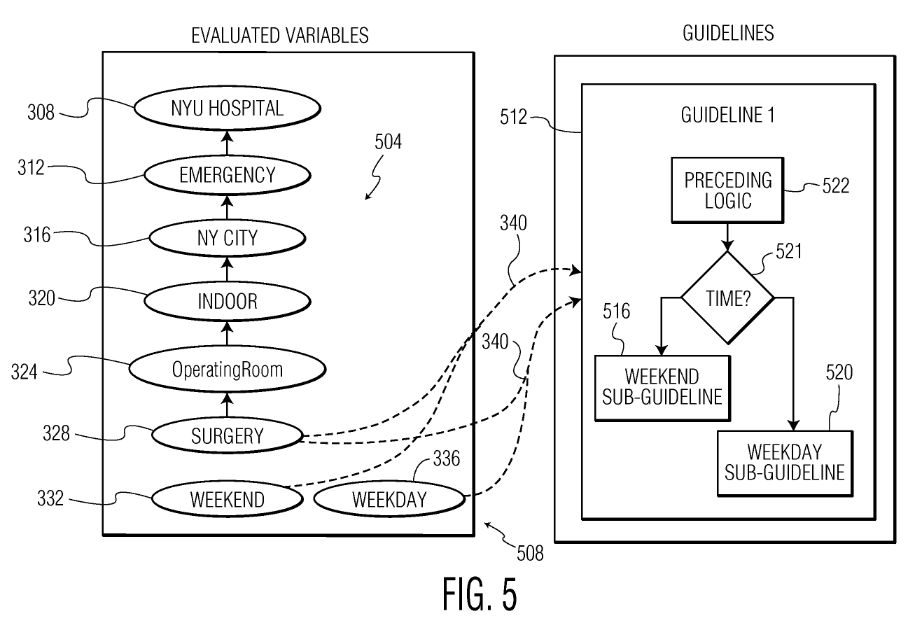

FIG. 5 is a conceptual diagram of a second embodiment demonstrating an instance of function evaluation in selecting a guideline for current operation, in accordance with the present invention; and

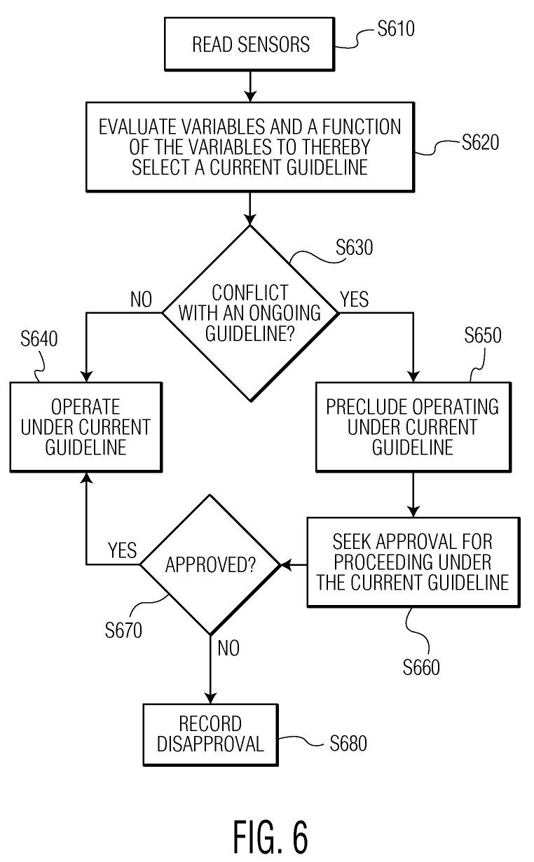

FIG. 6 is a flow chart of a procedure for operating under a selected guideline, in accordance with the present invention.

FIG. 1 shows, by way of illustrative and non-limitative example, a medical device 100 according to the present invention. The medical device 100 may incorporate a decision support system having a user interface by which to deliver decision support to a clinician. Alternatively, the medical device 100 may operate automatically, such as an intelligent ultrasound system that gathers input and, based upon the input, makes a real-time decision to pursue a next course of action. The device 100 includes a processor 110, memory 120 and situation sensors 130. The processor 110 has an ontology-based guideline identification module 140 and a guideline performing module 150. The use of ontologies to process output of the situation sensors 130 is preferable and is described in further detail below. Memory 120 may be volatile or non-volatile, and implemented as, or with, any of the varieties of random access memory (RAM), read-only memory (ROM) or flash memory, for example. The memory 120 in FIG. 1 is shown storing N medically-approved clinical guidelines 160. However, the medical device 100 may be designed for downloading additional medically-approved clinical guidelines 160 from a database of the enterprise, e.g., hospital or institution. The download, occurring before or during real-time operation of the device 100, may be needed to substitute a new counterpart guideline for an ongoing guideline, the counterpart better suiting a detected the current situation. Output of the situation sensors 130 may be used by the processor 110 for detecting or assessing the current situation. The device 100 accordingly follows, based on the determined situation, a particular guideline 160 already internal to the device 100 or downloaded for current operation. The guidelines offered for selection have been medically approved by a medical body, such as an accreditation organization, health care organization or expert medical peer group of the institution. Although the device 100 is described above in the context of a medical device, it is within the intended scope of the invention that the device 100 may be other than a medical device. For example, the device 100 may offer merely decision support, or otherwise act on its selection of a guideline for current execution without being applied directly in caring for the patient. Moreover, the present invention finds application in guidelines other than medical, and may be utilized in managing deployment of legal guidelines, computer troubleshooting guidelines, etc.

FIG. 2 conceptually depicts a particular example of partitioning a virtual coordinate system 200, according to the present invention. The coordinate system 200 is partitioned by n axes or variables, and a point is defined by n coordinates. In FIG. 2, n is set to 6, but might be less than or greater than 6. The time variable 210 shown has two possible values: week day 214 and weekend 218, although the variable may, alternatively or additionally, be multi-valued in correspondence with various clock time intervals. The other variables in FIG. 2 are activity 220, administrative 230, security 240, space 250 and location 260. Possible values for the activity variable 220 might include surgery, diagnostic scanning, angioplasty, tissue ablation, etc. Thus, if a medical device 100, in making a current evaluation of variables, detects that it is presently a weekend or night time, and that angioplasty is the planned procedure, the system might recommend thrombolysis as an alternative medical procedure, or might automatically select a corresponding clinical guideline 160 and execute the guideline. Possible values of the administrative variable 230 might include the Veteran's Health Administration (VHA) and Kaiser Permanente, both of which enterprises administer multiple hospitals. If evaluation of the administrative variable 230 yields the value VHA, certain policy pre-set by the VHA may influence or govern which guideline is recommended or automatically implemented. Although not shown in FIG. 2, regulatory variable might have, as a value, the Center for Medicare and Medicaid Systems (CMS). The security variable 240 could potentially have values like yellow, orange and red for the respective alert, and may vary, at any given time, with geographic location. Services and resources for non-emergency medical procedures could accordingly be restricted or curtailed. One possible division of the space variable domain is into indoor and outdoor. For example, the verbal instructions delivered by a portable defibrillator might be made to depend upon the value of the space variable 250 as determined from sensing techniques discussed further below. The location variable 260 can supplement the administrative variable, activity or security variable, for example, or may carry relevance in its own right. In one embodiment, as further discussed below, the current values of the variables are collectively mapped to a particular guideline 160, and one or more of the variables, but fewer than all, may serve to modify execution of that particular guideline. One point 270, for purposes of illustration, corresponds to a mapped-to guideline 160, whose execution varies in dependence upon the evaluation of the time variable 210. Another point 280 corresponds to the same guideline 160, but the time variable is differently valued, resulting in an altered execution path through the guideline.

FIG. 3 demonstrates, in a first embodiment, an instance of function evaluation in selecting a guideline for current operation, in accordance with the present invention. A function is defined herein as a mapping such that for each input value there exists only one output value. The set of input values comprises the domain. The set of outputs of the function based on the input values is the range. Notably, two input values of a function may map to the same output value.

In the illustrated embodiment, an input value 304 consists of seven values of respective variables. The variables are administrative, department, location, space, room, activity and time. Corresponding values shown in FIG. 3 are NYU hospital 308, emergency 312, New York City 316, indoor 320, operating room 324, surgery 328, and either weekday 332 or weekend 336. A first point (NYU hospital, emergency, indoor, operating room, surgery, weekday) corresponding to the input value 304 functionally maps, by means of a function 340, to a guideline 344. The function 340 is also applied, for purposes of demonstration, to a second point (NYU hospital, emergency, indoor, operating room, surgery, weekend) representing a second input value 348. Selection is correspondingly made of a different version 352 of the same guideline, i.e., a version of the guideline 344 which has been pre-modified for the different evaluation of the time variable, approved and released.

The situation sensors 130 are utilized in evaluating the variables to produce the input value 304, 348. The first four variables, for example, can be evaluated based on the output of a radio frequency (RF) transceiver embedded into the medical device 100. The transceiver sends an interrogating wireless signal that is picked up by an RF identification (RFID) transponder, which may be housed in a small, thin strip of material attached to the wall or other structure in the hospital. The RFID transponder or tag has an internal memory into which information can be recorded. Thus, within NYU hospital, the memory in each RFID tag according to the present embodiment, would contain at least the designation “NYU hospital.” Evaluation of the variables may rely on information obtained other than by the situation sensors 130. Through an online connection with an electronic medical record (EMR) system, the medical device can, based on detecting certain hospital codes, infer that surgery is the activity. Nor are the sensors 130 restricted to RF detection. The situation can be assessed based on magnetic input, image or audio input, or by means of mechanical sensors, for example. As another example, the time variable can be evaluated from an internal timer of the medical device 100 or from an externally originating time signal, as from the EMR. Moreover, the sensors 130 need not be limited to sensing the immediate ambient environment. The sensors 130 might, for example, receive situation information from wireless communication hubs. Current location, as another example, could be communicated via satellite by means of the Global Positioning System (GPS) protocol.

An administrator may maintain the function 340 to provide the proper mappings. The function is preferably modeled on different levels of abstractions using the World Wide Web Consortium's Web Ontology Language (OWL). These levels can be represented, for example, by a realm ontology, a general-level ontology and a domain-specific ontology.

FIG. 4 demonstrates an example of how functional mapping to identify a guideline for current execution is organized according to ontology. The realm ontology can be defined by boundaries that correspond to the administrative variable. Thus, the administrative variable is defined as part of an ontology under OWL or any other known and suitable ontology language. Other boundaries within the realm ontology might be regulatory and security, which have been discussed above. A general-level ontology is a high-level ontology that provides general features of basic entities. It captures concepts such as space, location, time, user, device and activity. A domain-specific ontology defines the details of general concepts and their features in each domain. Different domains have different understandings on general-level concepts. For example, in a clinical domain, a room can be a patient room, an operating room or a radiology reading room.

There are a number of advantages to defining these levels via ontologies. The virtual space drawing, implemented with OWL for example, can be machine generated. Machine automated tools can help an administrator to traverse the deployment and allocation of guidelines to points in the virtual space. These tools can survey a gap analysis of guideline coverage in an institution, can study guideline usage in accordance to the defined spaces, and can perform other quality controls related to compliance of an institution to regulatory requirements. Machine automated tools can help in managing the evolution of the institution's allocation of guidelines as the institution structure changes, grows, or divests.

FIG. 5 demonstrates, in a second embodiment, an instance of function evaluation in selecting a guideline for current operation, in accordance with the present invention. An input value 504, as in the first embodiment of FIG. 3, consists of seven values of respective variables, the variables being administrative, department, location, space, room, activity and time. Likewise, corresponding values are NYU hospital 308, emergency 312, New York City 316, indoor 320, operating room 324, surgery 328, and either weekday 332 or weekend 336. However, in contrast to the first embodiment, the two input values 504, 508, incorporating weekday 332 and weekend 336 respectively, are mapped to the same functional value, i.e., to the same guideline 512. The latter has been formulated with two sub-guidelines or sub-structures 516, 520. Each sub-structure has a remaining portion, such that the sub-structure and remaining portion comprise the entire guideline 512. Each sub-structure 516, 520 is self-contained so that its execution does not branch to its respective remaining portion. In particular, the remaining portion 521 of the first sub-structure 516 consists of the logic 522 that precedes it and the other sub-structure 520. Flow of execution through the guideline 512 accordingly varies with value of the time variable. In particular, if the value is weekend, the first sub-structure 516 is performed; whereas, if the value if week day, the second sub-structure 520 is performed. In the current example, the structure of the guideline 512 has been specifically tailored to each of the values of one variable evaluated in evaluating the function that selects this guideline. However, the specific tailoring of the guideline structure may be based on more than one, but less than all, of the variables defining the domain of the function. It is thus within the intended scope of the invention that division of the flow of execution in the guideline 512 into the various self-contained logical sub-structures potentially be governed by more than merely a single binary decision 521, each sub-structure corresponding to a unique combination of variable values. The two or more self-contained sub-structures may be present in only some of the guidelines within the range of the function; thus, the first and second embodiments (FIGS. 3 and 5) may be mixed in the functional mapping of the enterprise. Alternatively, the sub-structures need not be self-contained, so that one can lead to another or to any preceding or subsequent logic.

In FIG. 6, a guideline 160 that the medical device 100 automatically invokes is subject to prior approval if it differs from an ongoing, customary or expected guideline. In step S610, the situation sensors sense values of the variables, which are then read by the processor 110. The guideline identification module 140 then evaluates the variables, and a function of the variables, to thereby select a guideline 160 for current operation (step S620). Variables may also be evaluated by reading the EMR, for example. Query is now made as to whether the current guideline conflicts with an ongoing guideline (step S630). One example of such a medical device 100 is an ultrasound scanning system being applied to check head dimensions of a fetus in a pregnant woman. If head diameter is found to be smaller than a predetermined threshold, the selected guideline 160 calls for additional measurements to be automatically taken by the device 100. The device 100 may be one of many identical devices distributed to, among other countries, Korea, Japan, China and the United States. Since, on average, head diameter in the former-mentioned countries is smaller than in the United States, the situation sensors 130 check the EMR to determine the race of the woman, or the fetus. Alternatively or in addition, visual scanning of the mother can determine race by techniques well-known in the art. If this particular device 100 is located in an oriental country, the device may repeatedly determine a corresponding race. In the event, however, a non-oriental woman or fetus is scanned, the device should be operating under a different clinical guideline, one with a corresponding greater head diameter threshold. This different or current guideline 160 may conflict with the ongoing guideline 160 tailored to women in Korea, Japan or China, in terms of the medical procedure to be pursued. The determination that a guideline 160 is ongoing can be made by monitoring which guidelines are selected over time. If, as typically might occur on this device, the woman now to be scanned is determined to be oriental, no conflict exists. If no conflict exists, the device 100 operates under the current guideline (step S640). On the other hand, if conflict exists (step S630), operation under the current guideline is precluded (step S650), as a precaution. Approval is then sought for proceeding with the current guideline (step S660). This may take the form of a query to the clinician over the user interface. If proceeding with the current guideline is approved (step S670), the device 100 then operates under the current guideline. Otherwise, if proceeding with the current guideline is denied (step S680), the disapproval is recorded for subsequent quality control.

Another example of seeking pre-approval would be an emergency response situation resulting from a terrorist attack. The medical device 100 might, upon sensing a code red alert, propose invoking a guideline that saves time or resources, while somewhat compromising an otherwise optimal medical protocol. In that event, medical care during a particular state of security is subject to override by the clinician in step S670. Optionally, the potential for override in steps S630 and S650-S680 can be bypassed.

As has been demonstrated above, variable and ambiguous factors in clinical guideline execution are further defined by prior expert medical scrutiny and testing. The definitions promote uniformity and ease of use, and afford efficient interpretation by a medical device which can variably invoke the guideline suited to the sensed current situation. Moreover, the definitions facilitate enterprise-wide administration and maintenance of the rules under which a guideline for current operation is selected, preferably based on an ontology language such as OWL.

While there have shown and described and pointed out fundamental novel features of the invention as applied to preferred embodiments thereof, it will be understood that various omissions and substitutions and changes in the form and details of the devices illustrated, and in their operation, may be made by those skilled in the art without departing from the spirit of the invention. For example, although the present invention is discussed above in the context of a hospital or institution, the invention finds application in a factory, plant, military base, or office building. It should be recognized that structures and/or elements and/or method steps shown and/or described in connection with any disclosed form or embodiment of the invention may be incorporated in any other disclosed or described or suggested form or embodiment as a general matter of design choice.

1. A method for managing automatic deployment of care processes, comprising:
formulating, for patient care, a clinical guideline (512) comprising logical structure (516) that has been specifically tailored to at least one value of at least one, but fewer than all, of a plurality of variables;
medically approving and releasing the formulated guideline (160); and
evaluating, by a processor, a function of said plurality of variables to select, from among a plurality of clinical guidelines, the released guideline for current execution, each of the plural clinical guidelines being within a range of said function (S620).

2. The method of claim 1, wherein said evaluating comprises utilizing a value of said at least one value (132).

3. The method of claim 1, wherein said structure is self-contained so that execution of said structure does not branch to a remaining portion (522) of the said guideline.

4. The method of claim 1, wherein said structure is said guideline (344).

5. The method of claim 1, wherein said structure (516) is a logical sub-structure of said released guideline, said released guideline further comprising a logical sub-structure (520) that has been specifically tailored to another at least one value of said at least one of the plural variables, said evaluating further selecting between the logical sub-structures.

6. A method for automated medical care, said method comprising:
operating a medical device so that said device identifies a medically-approved clinical guideline for current execution (S620); and
responsive to the identification, automatically performing, by said device, the identified guideline (S640).

7. The method of claim 6, further comprising:
determining whether a conflict exists between said identified guideline and another medically-approved clinical guideline (S630); and
precluding said performing if said determining determines that said conflict exists (S650).

8. The method of claim 7, wherein said another guideline is an ongoing guideline, said method further comprising:
in case of said conflict, deciding whether to proceed with said performing (S660, S670); and
if said identified guideline is not adopted, recording disapproval for switching to the identified guideline (S680).

9. The method of claim 7, wherein said another guideline has been selected by evaluating a function (340) of at least current time (332) and current spatial location (320).

10. The method of claim 6, wherein said identified guideline has been selected by evaluating a function (340) of a plurality of variables, a variable of the plural variables being a current state of security in a locality of said medical device.

11. A computer software product for managing automatic deployment of care processes comprising a computer readable medium (120) into which is embedded a program having instructions executable to perform acts comprising:
evaluating a function of a plurality of variables to select, from among a plurality of clinical guidelines for patient care, a medically-approved and released guideline for current execution (S620), each of the plural clinical guidelines being within a range of said function, the selected guideline comprising logical structure (516) that has been specifically tailored to at least one value of at least one, but fewer than all, of the plural variables; and
outputting an identifier of the selection made.

12. An apparatus for managing automatic deployment of processes comprising:
a memory for storing a plurality of guidelines (120); and
a processor (110) configured for evaluating a function of a plurality of variables to select, from among the plural guidelines, an approved and released guideline for current execution, each of the plural guidelines being within a range of said function, said guideline comprising logical structure that has been specifically tailored to at least one value of at least one, but fewer than all, of the plural variables.

13. The apparatus of claim 12, wherein said processes are care processes, the plural guidelines are clinical guidelines, and the approved guideline is medically-approved (160).

14. The apparatus of claim 13, wherein said evaluating comprises utilizing a value of said at least one value (332).

15. The apparatus of claim 13, wherein said structure is self-contained so that execution of said structure does not branch to a remaining portion (522, 520) of the said guideline.

16. The apparatus of claim 13, wherein said structure is the selected guideline (344).

17. The apparatus of claim 13, wherein said structure is a logical sub-structure (516) of the selected guideline, said guideline further comprising a logical sub-structure (520) that has been specifically tailored to another at least one value of said at least one of the plural variables, said evaluating further selecting between the logical sub-structures.

18. The apparatus of claim 13, wherein said processor includes an automated tool that includes ontologies among which the plural variables are allocated (140).

19. A system for managing automatic deployment of care processes, comprising the apparatus of claim 13, said apparatus further comprising a situation sensor (130), said system further comprising a wireless transmitter for communicating with said sensor.

20. A medical device for automated medical care, comprising:
a guideline identification module (140) configured for identifying a medically-approved clinical guideline for current execution; and
a guideline performing module (150) configured for, responsive to the identification, automatically performing the identified guideline.

21. The medical device of claim 20, wherein said guideline performing module is further configured for:
determining whether a conflict exists between said identified guideline and another medically-approved clinical guideline (S630); and
precluding said performing if said determining determines that said conflict exists (S650).

22. The medical device of claim 21, wherein said another guideline is an ongoing guideline (S630), and has been selected by evaluating a function of at least current time and current spatial location.

23. The medical device of claim 20, wherein said identified guideline has been selected by evaluating a function (340) of a plurality of variables, a variable of the plural variables being a current state of security in a locality of said medical device.

24. The medical device of claim 20, wherein said guideline identification module includes a sensor (130) for evaluating a variable, and a function of said variable, in performing said identifying (S620).

25. The medical device of claim 20, wherein said guideline identification module comprises an automated tool that includes ontologies among which a plurality of variables are allocated (140), said guideline identification module being configured for said identifying based on evaluation of a function of the plural variables.
